(19) United States
(12) Patent Application Publication
(10) Pub. No.: US 2026/0046382 A1
(43) Pub. Date: Feb. 12, 2026

(54) PROJECTION APPARATUS, CONTROL METHOD, AND CONTROL PROGRAM

(71) Applicant: FUJIFILM Corporation, Tokyo (JP)

(72) Inventors: Kazuki INOUE, Saitama (JP); Hitoshi SATO, Saitama (JP); Akihiro ISHIZUKA, Saitama (JP)

(73) Assignee: FUJIFILM Corporation, Tokyo (JP)

(21) Appl. No.: 19/366,409

(22) Filed: Oct. 22, 2025

Related U.S. Application Data
(63) Continuation of application No. PCT/JP2024/012235, filed on Mar. 27, 2024.

(30) Foreign Application Priority Data
Apr. 24, 2023 (JP) 2023-070608

(51) Int. Cl. H04N 9/31; G09G 3/00; G09G 3/36

(52) U.S. Cl. CPC H04N 9/3185; G09G 3/002; G09G 3/3611; G09G 2320/0233; G09G 2320/0257; G09G 2320/062; G09G 2340/0464; G09G 2340/14; G09G 2360/16; H04N 9/3164

(57) ABSTRACT

A projection apparatus that is able to shift a projection image includes: a projection lens; and a processor. The processor is configured to: acquire information related to an installation state of the projection apparatus; and perform a control of restricting shifting of the projection image in accordance with the installation state and a state of a light source of the projection apparatus.

### CROSS-REFERENCE TO RELATED APPLICATIONS

This is a continuation of International Application No. PCT/JP2024/012235 filed on Mar. 27, 2024, and claims priority from Japanese Patent Application No. 2023-070608 filed on Apr. 24, 2023, the entire content of which is incorporated herein by reference.

### BACKGROUND OF THE INVENTION

### 1. Field of the Invention

The present invention relates to a projection apparatus, a control method, and a storage medium storing a control program.

### 2. Description of the Related Art

JP2014-163954A discloses a projector comprising a control portion, a lens shift driving portion, and an obstacle detection portion, in which the obstacle detection portion detects an obstacle (a person or the like) in an image projection region via a distance sensor, and the control portion, in a case where the obstacle is detected, provides an instruction to the lens shift driving portion to shift a lens to a projection region in which the obstacle is not present.

JP2009-075147A discloses a projector comprising a central processing unit (CPU), a projection optical system adjustment portion, an acceleration sensor, and a distance sensor, in which the projection optical system adjustment portion has an electric zoom function, an electric focus function, and an electric lens shift function, the acceleration sensor detects an amount of change in a position of the projector, the distance sensor measures a distance from the projector to a screen, and the CPU adjusts and controls the electric zoom function, the electric focus function, and the electric lens shift function such that a position, a shape, and a size of a projection image can be maintained even in a case where an installation position of the projector or the distance from the projector to the screen changes.

JP2022-095141A discloses a projector comprising a shift allowance plate including an opening that is in a similar form to a shift allowance range and that has a size less than or equal to that of the shift allowance range, and a through-hole through which light emitted from a light-emitting portion passes; a projection lens that is disposed in the opening and that displaces the shift allowance plate by displacing in any direction; a detector that detects displacement of the projection lens to a limit position based on a light reception state of light of a light reception portion, and a controller that stops the displacement of the projection lens when the detector detects displacement of the shift allowance plate to the limit position based on the displacement of the projection lens.

### SUMMARY OF THE INVENTION

One embodiment according to the disclosed technology provides a projection apparatus, a control method, and a storage medium storing a control program capable of reducing a ghost during projection.

(1)

A projection apparatus that is able to shift a projection image, the projection apparatus comprising a projection lens, and a processor, in which the processor is configured to acquire information related to an installation state of the projection apparatus, and perform a control of restricting shifting of the projection image in accordance with the installation state.

(2)

The projection apparatus according to (1), in which the installation state is a state related to a positional relationship between the projection lens and an object as an installation target of the projection apparatus.

(3)

The projection apparatus according to (1) or (2), in which the installation state includes an embedded state where at least a part of the projection apparatus is embedded in an object as an installation target of the projection apparatus.

(4)

The projection apparatus according to (3), in which the processor is configured to impose a stronger restriction on the shifting in the embedded state than in the installation state different from the embedded state.

(5)

The projection apparatus according to any one of (1) to (4), in which the information related to the installation state includes information related to a distance between the projection lens and an object, other than the projection apparatus, that is closest to the projection lens, and the processor is configured to restrict the shifting in accordance with the distance.

(6)

The projection apparatus according to any one of (1) to (4), in which the information related to the installation state includes information related to a distance between the projection lens and an object as an installation target of the projection apparatus, and the processor is configured to restrict the shifting in accordance with the distance.

(7)

The projection apparatus according to any one of (1) to (6), in which the processor is configured to restrict the shifting in a direction corresponding to a positional relationship between the projection lens and an object as an installation target of the projection apparatus.

(8)

The projection apparatus according to any one of (1) to (7), in which the processor is configured to perform the control of restricting the shifting in accordance with the installation state and a state of a light source of the projection apparatus.

(9)

The projection apparatus according to (8), in which the state of the light source includes a state of an output value of the light source.

(10)

The projection apparatus according to (9), in which the processor is configured to, in a case where the output value is a first output value, impose a stronger restriction on the shifting than in a case where the output value is a second output value lower than the first output value.

(11)

The projection apparatus according to any one of (1) to (6), in which the processor is configured to control an output value of a light source of the projection apparatus based on a state of the shifting.

(12)

The projection apparatus according to any one of (1) to (11), in which the processor is configured to perform the control of restricting the shifting in accordance with the installation state and image content of the projection image.

(13)

The projection apparatus according to (12), in which the processor is configured to perform the control of restricting the shifting in accordance with the installation state and brightness of the image content of the projection image.

(14)

The projection apparatus according to (13), in which the processor is configured to restrict the shifting in a direction corresponding to brightness of a plurality of end portion regions in the image content of the projection image.

(15)

The projection apparatus according to any one of (1) to (14), in which the processor is configured to, in a case where information related to the restriction of the shifting changes during projection of the projection image, maintain a state of the shifting.

(16)

The projection apparatus according to (15), in which the processor is configured to, in a case where a user operation related to the shifting is performed in a state where the state of the shifting is maintained, change the state of the shifting in accordance with the information related to the restriction of the shifting.

(17)

The projection apparatus according to any one of (1) to (16), in which the shifting is shifting in a direction perpendicular to an optical axis direction of the projection lens.

(18)

A control method of a projection apparatus that is able to shift a projection image, the projection apparatus including a projection lens, and a processor, the control method comprising, via the processor, acquiring information related to an installation state of the projection apparatus, and performing a control of restricting shifting of the projection image in accordance with the installation state.

(19)

A non-transitory computer-readable storage medium storing a control program of a projection apparatus that is able to shift a projection image, the projection apparatus including a projection lens, and a processor, the control program causing the processor to execute a process comprising acquiring information related to an installation state of the projection apparatus, and performing a control of restricting shifting of the projection image in accordance with the installation state.

According to the present invention, a projection apparatus, a control method, and a storage medium storing a control program capable of reducing a ghost during projection can be provided.

### BRIEF DESCRIPTION OF THE DRAWINGS

FIG. 1 is a schematic diagram illustrating an example of a projection apparatus 10 that is an installation support target of an information processing apparatus according to an embodiment.

FIG. 2 is a schematic diagram illustrating an example of an internal configuration of a projection portion 1 illustrated in FIG. 1.

FIG. 3 is a schematic diagram illustrating an exterior configuration of the projection apparatus 10.

FIG. 4 is a schematic cross-sectional view of an optical unit 106 of the projection apparatus 10 illustrated in FIG. 3.

FIG. 5 is a diagram illustrating an example of an installation state of the projection apparatus 10.

FIG. 6 is a diagram illustrating another example of the installation state of the projection apparatus 10.

FIG. 7 is a diagram illustrating an example of an installation state where the projection apparatus 10 is embedded in a ceiling.

FIG. 8 is a diagram after a position of a projection image G1 is shifted in the projection apparatus 10 illustrated in FIG. 7.

FIG. 9 is a diagram for describing an example of shift restriction of the projection image G1.

FIG. 10 is a flowchart illustrating a first processing example in the shift restriction of the projection apparatus 10.

FIG. 11 is a diagram illustrating an example of a shift restriction table in the first processing example.

FIG. 12 is a flowchart illustrating a second processing example in the shift restriction of the projection apparatus 10.

FIG. 13 is a diagram illustrating an example of a black band region in the projection image G1.

FIG. 14 is a diagram illustrating an example of the shift restriction table in the second processing example.

FIG. 15 is a flowchart illustrating a first processing example of output value restriction of a light source 21 with respect to a shift position of the projection image G1.

FIG. 16 is a diagram illustrating an example of an output value restriction table in the first processing example.

FIG. 17 is a flowchart illustrating a second processing example of the output value restriction of the light source 21 with respect to the shift position of the projection image G1.

FIG. 18 is a diagram illustrating an example of the output value restriction table in the second processing example.

FIG. 19 is a flowchart illustrating a first modification example of the shift restriction of the projection apparatus 10.

FIG. 20 is a diagram illustrating an example of the shift restriction table in the first modification example.

FIG. 21 is a diagram illustrating a modification example of a configuration of the projection apparatus 10.

FIG. 22 is a diagram illustrating an example of a hardware configuration of a personal computer 200.

### DESCRIPTION OF THE PREFERRED EMBODIMENTS

Hereinafter, an example of an embodiment of the present invention will be described with reference to the drawings.

### <Projection Apparatus 10 of Embodiment>

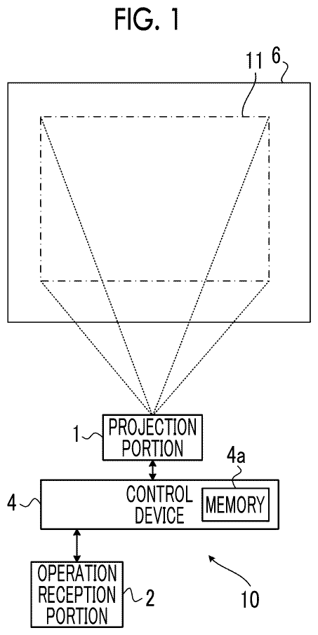

FIG. 1 is a schematic diagram illustrating an example of a projection apparatus 10 of the embodiment. As illustrated in FIG. 1, the projection apparatus 10 comprises a projection portion 1, a control device 4, and an operation reception portion 2. The projection portion 1 is composed of, for example, a liquid crystal projector or of a projector using liquid crystal on silicon (LCoS). Hereinafter, the projection portion 1 will be described as a liquid crystal projector. The projection portion 1 projects a projection image to a projection object 6.

The control device 4 is a control device that controls projection performed by the projection apparatus 10. The control device 4 is a device including a control portion composed of various processors, a communication interface (not illustrated) for communicating with each portion, and a memory 4a such as a hard disk, a solid-state drive (SSD), or a read-only memory (ROM) and controls the projection portion 1 in an integrated manner.

Examples of the various processors of the control portion of the control device 4 include a central processing unit (CPU) that is a general-purpose processor performing various types of processing by executing a program, a programmable logic device (PLD) such as a field-programmable gate array (FPGA) that is a processor having a circuit configuration changeable after manufacture, or a dedicated electric circuit such as an application specific integrated circuit (ASIC) that is a processor having a circuit configuration dedicatedly designed to execute specific processing.

More specifically, a structure of these various processors is an electric circuit in which circuit elements such as semiconductor elements are combined. The control portion of the control device 4 may be composed of one of the various processors or may be composed of a combination of two or more processors of the same type or different types (for example, a combination of a plurality of FPGAs or a combination of a CPU and an FPGA). The control device 4 is an example of a “processor” according to the embodiment of the present invention.

The operation reception portion 2 detects an instruction from a user by receiving various operations from the user. The operation reception portion 2 may be a button, a key, a joystick, or the like provided in the control device 4 or may be a reception portion or the like that receives a control signal from a remote controller for remotely operating the control device 4.

The projection object 6 is an object such as a screen or a wall including a projection surface on which the projection image is displayed by the projection portion 1. In the example illustrated in FIG. 1, the projection surface of the projection object 6 is a rectangular plane. It is assumed that upper, lower, left, and right sides of the projection object 6 in FIG. 1 are upper, lower, left, and right sides of the actual projection object 6.

A projection range 11 illustrated by a dot dashed line is a region irradiated with projection light by the projection portion 1 in the projection object 6. In the example illustrated in FIG. 1, the projection range 11 is rectangular. The projection range 11 is a part or the entirety of a projectable range to which the projection can be performed by the projection portion 1.

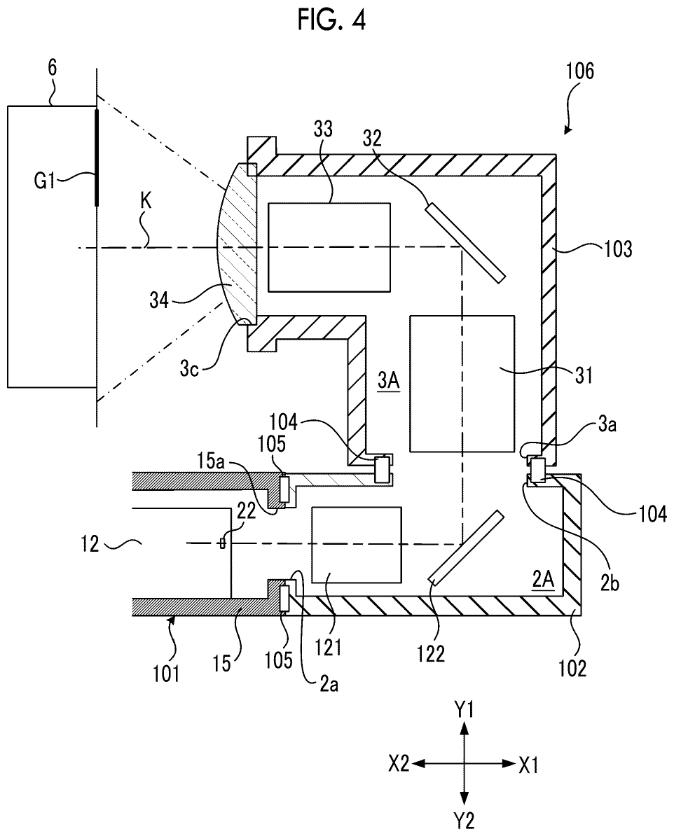

The projection portion 1, the control device 4, and the operation reception portion 2 are implemented by, for example, one device (for example, refer to FIG. 3 and FIG. 4). Alternatively, the projection portion 1, the control device 4, and the operation reception portion 2 may be separate devices that cooperate with each other through communication.

### <Internal Configuration of Projection Portion 1 Illustrated in FIG. 1>

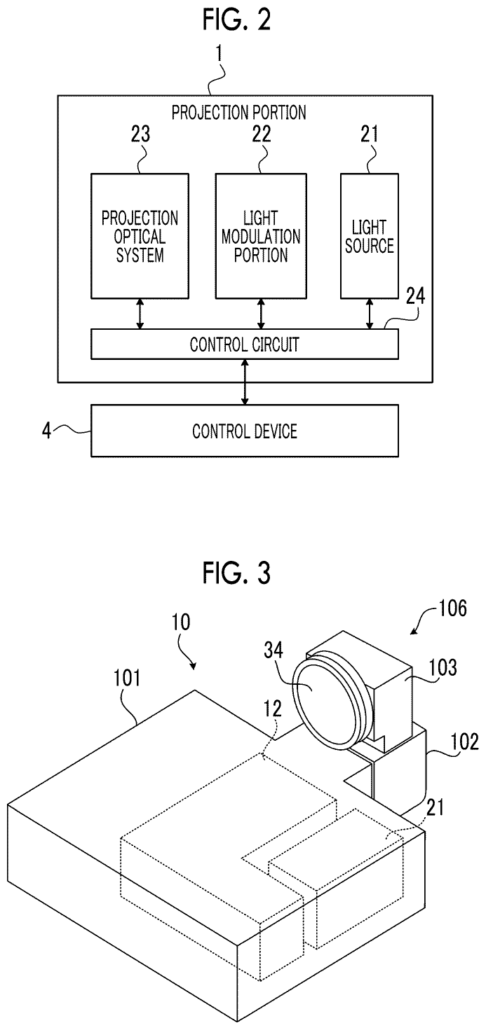

FIG. 2 is a schematic diagram illustrating an example of an internal configuration of the projection portion 1 illustrated in FIG. 1.

As illustrated in FIG. 2, the projection portion 1 comprises a light source 21, a light modulation portion 22, a projection optical system 23, and a control circuit 24.

The light source 21 includes a light emitting element such as a laser or a light emitting diode (LED) and emits, for example, white light.

The light modulation portion 22 is composed of three liquid crystal panels that modulate, based on image information, color light of each of three colors of red, blue, and green which is emitted from the light source 21 and which is separated by a color separation mechanism (not illustrated) and that emit images of each color. Filters of red, blue, and green may be mounted in the three liquid crystal panels, respectively, and the images of each color may be emitted by modulating the white light emitted from the light source 21 in each liquid crystal panel.

The light from the light source 21 and the light modulation portion 22 is incident on the projection optical system 23. The projection optical system 23 includes at least one lens and is composed of, for example, a relay optical system. The light that has passed through the projection optical system 23 is projected to the projection object 6.

In the projection object 6, a region irradiated with the light transmitted through the entire range of the light modulation portion 22 is the projectable range to which the projection can be performed by the projection portion 1. In the projectable range, a region irradiated with the light actually transmitted through the light modulation portion 22 is the projection range 11. For example, in the projectable range, a size, a position, and a shape of the projection range 11 are changed by controlling a size, a position, and a shape of a region through which the light is transmitted in the light modulation portion 22.

The control circuit 24 projects an image based on display data to the projection object 6 by controlling the light source 21, the light modulation portion 22, and the projection optical system 23 based on the display data input from the control device 4. The display data input into the control circuit 24 is composed of three constituents of red display data, blue display data, and green display data.

In addition, the control circuit 24 enlarges or reduces the projection range 11 (refer to FIG. 1) of the projection portion 1 by changing the projection optical system 23 based on an instruction input from the control device 4. Alternatively, the control device 4 may move the projection range 11 of the projection portion 1 by changing the projection optical system 23 based on the operation received by the operation reception portion 2 from the user.

In addition, the projection apparatus 10 comprises a shift mechanism that mechanically or optically moves the projection range 11 while maintaining an image circle of the projection optical system 23. The image circle of the projection optical system 23 is a region in which the projection light incident on the projection optical system 23 appropriately passes through the projection optical system 23 in terms of a light fall-off, color separation, edge part curvature, or the like.

The shift mechanism is implemented by at least any of an optical system shift mechanism that performs optical system shifting, or an electronic shift mechanism that performs electronic shifting.

The optical system shift mechanism is, for example, a mechanism (for example, refer to FIG. 3 and FIG. 4) that moves the projection optical system 23 in a direction perpendicular to an optical axis, or a mechanism that moves the light modulation portion 22 in the direction perpendicular to the optical axis instead of moving the projection optical system 23. Alternatively, the optical system shift mechanism may perform the movement of the projection optical system 23 and the movement of the light modulation portion 22 in combination.

The electronic shift mechanism is a mechanism that performs pseudo shifting of the projection range 11 by changing a range through which the light is transmitted in the light modulation portion 22.

In addition, the projection apparatus 10 may comprise a projection direction changing mechanism that moves the image circle of the projection optical system 23 and the projection range 11. The projection direction changing mechanism is a mechanism that changes a projection direction of the projection portion 1 by changing a direction of the projection portion 1 through mechanical rotation (for example, refer to FIG. 3 and FIG. 4).

The control circuit 24 moves the projection range 11 of the projection portion 1 by controlling the shift mechanism or the projection direction changing mechanism based on the instruction input from the control device 4.

### <Mechanical Configuration of Projection Apparatus 10>

FIG. 3 is a schematic diagram illustrating an example of an exterior configuration of the projection apparatus 10. FIG. 4 is a schematic cross-sectional view of an optical unit 106 of the projection apparatus 10 illustrated in FIG. 3. FIG. 4 illustrates a cross section in a plane along an optical path of the light emitted from a body part 101 illustrated in FIG. 3.

As illustrated in FIG. 3, the projection apparatus 10 comprises the body part 101 and the optical unit 106 that is provided to protrude from the body part 101. In the configuration illustrated in FIG. 3, the operation reception portion 2, the control device 4, and the light source 21, the light modulation portion 22, and the control circuit 24 in the projection portion 1 are provided in the body part 101. The projection optical system 23 in the projection portion 1 is provided in the optical unit 106.

The optical unit 106 comprises a first member 102 supported by the body part 101 and a second member 103 supported by the first member 102.

The first member 102 and the second member 103 may be an integrated member. The optical unit 106 may be configured to be attachable to and detachable from the body part 101 (in other words, configured to be interchangeable).

The body part 101 includes a housing 15 (refer to FIG. 4) in which an opening 15a (refer to FIG. 4) for passing light is formed in a part connected to the optical unit 106.

As illustrated in FIG. 3, the light source 21 and a light modulation unit 12 including the light modulation portion 22 (refer to FIG. 2) that generates an image by spatially modulating the light emitted from the light source 21 based on input image data are provided inside the housing 15 of the body part 101.

The light emitted from the light source 21 is incident on the light modulation portion 22 of the light modulation unit 12 and is spatially modulated and emitted by the light modulation portion 22.

As illustrated in FIG. 4, the image formed from the light spatially modulated by the light modulation unit 12 is incident on the optical unit 106 by passing through the opening 15a of the housing 15 and is projected to the projection object 6 as a projection target object. Accordingly, a projection image G1 is visible to an observer. The projection image G1 is an image formed by the projection light with which the projection range 11 is irradiated. The projection image G1 is an example of a “projection image” according to the embodiment of the present invention.

As illustrated in FIG. 4, the optical unit 106 comprises the first member 102 including a hollow portion 2A connected to the inside of the body part 101, the second member 103 including a hollow portion 3A connected to the hollow portion 2A, a first optical system 121 and a reflective member 122 disposed in the hollow portion 2A, a second optical system 31, a reflective member 32, a third optical system 33, and a lens 34 disposed in the hollow portion 3A, a shift mechanism 105, and a projection direction changing mechanism 104.

The first member 102 is a member having, for example, a rectangular cross-sectional exterior shape, in which an opening 2a and an opening 2b are formed in surfaces perpendicular to each other. The first member 102 is supported by the body part 101 in a state where the opening 2a is disposed at a position facing the opening 15a of the body part 101. The light emitted from the light modulation portion 22 of the light modulation unit 12 of the body part 101 is incident into the hollow portion 2A of the first member 102 through the opening 15a and through the opening 2a.

An incidence direction of the light incident into the hollow portion 2A from the body part 101 will be referred to as a direction X1. A direction opposite to the direction X1 will be referred to as a direction X2. The direction X1 and the direction X2 will be collectively referred to as a direction X. In addition, a direction from the front to the back of the page of FIG. 4 and an opposite direction thereto will be referred to as a direction Z. In the direction Z, the direction from the front to the back of the page will be referred to as a direction Z1, and the direction from the back to the front of the page will be referred to as a direction Z2.

In addition, a direction perpendicular to the direction X and to the direction Z will be referred to as a direction Y. In the direction Y, an upward direction in FIG. 4 will be referred to as a direction Y1, and a downward direction in FIG. 4 will be referred to as a direction Y2. In the example in FIG. 4, the projection apparatus 10 is disposed such that the direction Y2 is a vertical direction.

The projection optical system 23 illustrated in FIG. 2 is composed of the first optical system 121, the reflective member 122, the second optical system 31, the reflective member 32, the third optical system 33, and the lens 34. An optical axis K of the projection optical system 23 is illustrated in FIG. 4. The first optical system 121, the reflective member 122, the second optical system 31, the reflective member 32, the third optical system 33, and the lens 34 are disposed in this order from the light modulation portion 22 side along the optical axis K.

The first optical system 121 includes at least one lens and guides the light that is incident on the first member 102 from the body part 101 and that travels in the direction X1, to the reflective member 122.

The reflective member 122 reflects the light incident from the first optical system 121 in the direction Y1. The reflective member 122 is composed of, for example, a mirror. In the first member 102, the opening 2b is formed on the optical path of the light reflected by the reflective member 122, and the reflected light travels to the hollow portion 3A of the second member 103 by passing through the opening 2b.

The second member 103 is a member having an approximately T-shaped cross-sectional exterior shape, in which an opening 3a is formed at a position facing the opening 2b of the first member 102. The light that has passed through the opening 2b of the first member 102 from the body part 101 is incident into the hollow portion 3A of the second member 103 through the opening 3a. Cross-sectional exterior shapes of the first member 102 and the second member 103 are arbitrary and are not limited to the above.

The second optical system 31 includes at least one lens and guides the light incident from the first member 102 to the reflective member 32.

The reflective member 32 guides the light incident from the second optical system 31 to the third optical system 33 by reflecting the light in the direction X2. The reflective member 32 is composed of, for example, a mirror.

The third optical system 33 includes at least one lens and guides the light reflected by the reflective member 32 to the lens 34.

The lens 34 is disposed in an end part of the second member 103 on the direction X2 side in the form of closing the opening 3c formed in this end part. The lens 34 projects the light incident from the third optical system 33 to the projection object 6. The lens 34 is an example of a “projection lens” according to the embodiment of the present invention.

The projection direction changing mechanism 104 is a rotation mechanism that rotatably connects the second member 103 to the first member 102. By the projection direction changing mechanism 104, the second member 103 is configured to be rotatable about a rotation axis (specifically, the optical axis K) that extends in the direction Y. The projection direction changing mechanism 104 is not limited to the disposition position illustrated in FIG. 4 as long as the projection direction changing mechanism 104 can rotate the optical system. In addition, the number of rotation mechanisms is not limited to one, and a plurality of rotation mechanisms may be provided.

The shift mechanism 105 is a mechanism for moving the optical axis K of the projection optical system (in other words, the optical unit 106) in a direction (direction Y in FIG. 4) perpendicular to the optical axis K. Specifically, the shift mechanism 105 is configured to be capable of changing a position of the first member 102 in the direction Y with respect to the body part 101. The shift mechanism 105 may manually move the first member 102 or electrically move the first member 102.

FIG. 4 illustrates a state where the first member 102 is moved as far as possible to the direction Y1 side by the shift mechanism 105. By moving the first member 102 in the direction Y2 via the shift mechanism 105 from the state illustrated in FIG. 4, a relative position between a center of the image (in other words, a center of a display surface) formed by the light modulation portion 22 and the optical axis K changes, and the projection image G1 projected to the projection object 6 can be shifted (translated) in the direction Y2.

The shift mechanism 105 may be a mechanism that moves the light modulation portion 22 in the direction Y instead of moving the optical unit 106 in the direction Y. Even in this case, the projection image G1 projected to the projection object 6 can be moved in the direction Y2.

### <Installation State of Projection Apparatus 10>

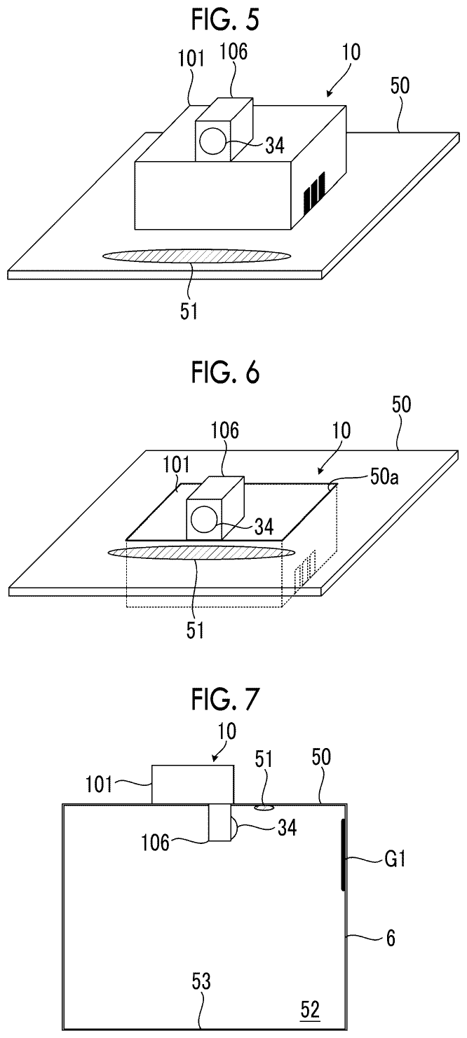

Next, an installation state of the projection apparatus 10 in a case where the projection apparatus 10 is used will be described. FIG. 5 is a diagram illustrating an example of the installation state of the projection apparatus 10. As illustrated in FIG. 5, for example, the projection apparatus 10 may be installed on an object 50 as an installation target in a non-embedded state. The object 50 as the installation target is, for example, a “floor”, a “wall”, a “ceiling”, a “pillar”, or a “seat”. The non-embedded state includes, for example, a state where the projection apparatus 10 is installed by bringing a part of the projection apparatus 10 into contact with the object 50 as the installation target, and a state where the projection apparatus 10 is installed at a distance from the object 50 as the installation target.

The state where the projection apparatus 10 is installed in partial contact with the object 50 as the installation target is, for example, a state where the projection apparatus 10 is placed on the floor or the seat, or a state where the projection apparatus 10 is attached to the wall, the ceiling, or the pillar. The state where the projection apparatus 10 is installed at a distance from the object 50 as the installation target is, for example, a state where the projection apparatus 10 is suspended from the ceiling via an attachment member in a state where the projection apparatus 10 is separated from the ceiling.

The installation example illustrated in FIG. 5 illustrates a state where the projection apparatus 10 is placed on the “floor” which is the object 50 as the installation target. The projection apparatus 10 illustrated in FIG. 5 is a simple illustration and is composed of the body part 101 having a box shape and the optical unit 106 having a box shape. The projection apparatus 10 is installed in a state where the body part 101 is in contact with the floor, and the optical unit 106 is provided on the body part 101. In addition, the optical unit 106 is provided with the lens 34 and configured to project light from the lens 34 to the projection object 6.

In a case where the projection apparatus 10 is installed in such a manner, the projection image G1 is formed by irradiating the projection object 6 with the light that has appropriately passed through the lens 34. However, in a case where a part of the light that is irregularly reflected in the lens 34 is output from the lens 34, for example, as illustrated in FIG. 5, the floor is irradiated with the light, and a bright shining region (hereinafter, referred to as a ghost 51) appears. A location in which the ghost 51 is likely to appear is on an object present around the front of the lens 34. The region and intensity (brightness) of appearance of the ghost 51 change depending on a distance between the object and the lens 34, intensity of the light output from the lens 34, a projection position of the projection image G1 projected from the lens 34, and the like.

FIG. 6 is a diagram illustrating another example of the installation state of the projection apparatus 10. As illustrated in FIG. 6, for example, the projection apparatus 10 may be installed on the object 50 as the installation target in an embedded state. The embedded state includes, for example, a state where the projection apparatus 10 is installed by embedding a part of the projection apparatus 10 in the object 50 as the installation target.

The state where the projection apparatus 10 is installed by embedding a part of the projection apparatus 10 in the object 50 as the installation target means, for example, a state where a part of the projection apparatus 10 is accommodated in a predetermined space formed in the floor, the wall, the ceiling, the pillar, or the seat.

The installation example illustrated in FIG. 6 illustrates a state where the projection apparatus 10 is embedded in the “wall” which is the object 50 as the installation target. The projection apparatus 10 illustrated by the body part 101 having a box shape and the optical unit 106 having a box shape is installed in a state where the body part 101 is accommodated in an accommodation space 50a formed in the wall, and the optical unit 106 provided on the body part 101 protrudes from the wall.

Even in a case where the projection apparatus 10 is installed in such a manner, the projection image G1 is formed by irradiating the projection object 6 with the light that has appropriately passed through the lens 34. However, in a case where a part of the light that is irregularly reflected in the lens 34 is output from the lens 34, for example, as illustrated in FIG. 6, the wall is irradiated with the light, and the ghost 51 appears. The location in which the ghost 51 is likely to appear is on the object present around the front of the lens 34, as in the above case in FIG. 5. In addition, the region and the intensity (brightness) of the appearance of the ghost 51 change depending on the distance between the object and the lens 34, the intensity of the light output from the lens 34, the projection position of the projection image G1 projected from the lens 34, and the like.

### <Example of Installation State Where Ghost 51 Does Not Appear>

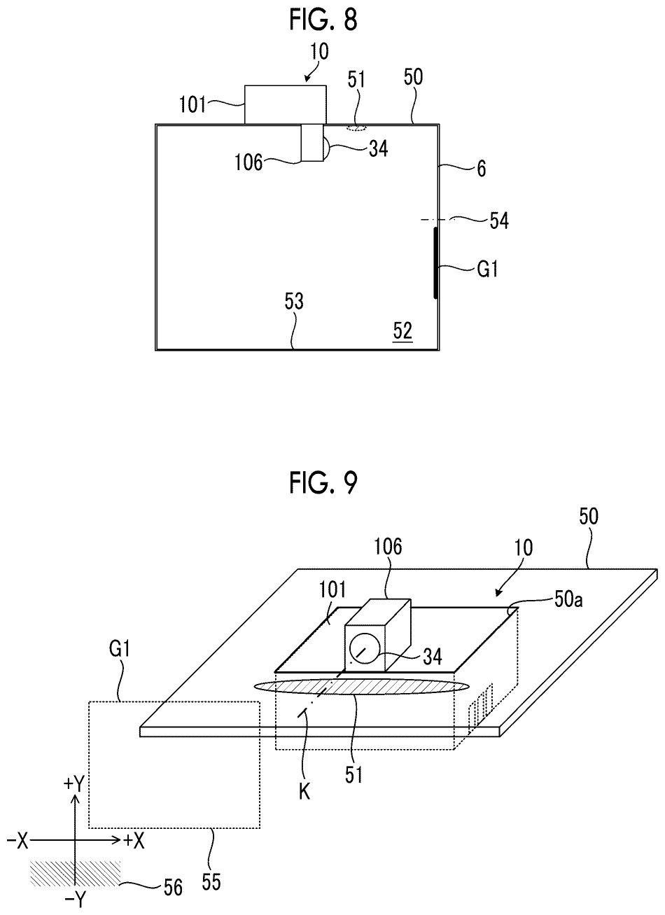

Next, the installation state of the projection apparatus 10 for preventing the ghost 51 from appearing will be described. FIG. 7 and FIG. 8 are diagrams illustrating an example of the installation state where the projection apparatus 10 is embedded in the ceiling. As illustrated in FIG. 7 and FIG. 8, the projection apparatus 10 is installed in a projection room 52 in a state where the body part 101 is disposed on the “ceiling” which is the object 50 as the installation target, and the optical unit 106 provided on the body part 101 protrudes downward from the ceiling.

Here, FIG. 7 and FIG. 8 are compared with each other. In FIG. 7, the projection image G1 projected from the lens 34 of the projection apparatus 10 is projected to an upper region of the projection object 6. Meanwhile, in FIG. 8, the projection position of the projection image G1 is projected to a lower region below the projection position illustrated in FIG. 7. That is, in FIG. 7, a shift control of the projection position is performed such that the projection image G1 is projected to the upper region close to the “ceiling” which is the object 50 as the installation target of the projection apparatus 10. Meanwhile, in FIG. 8, a shift control of the projection position is performed such that the projection image G1 is projected to the lower region close to a floor 53 of the projection room 52 in a direction going from the ceiling.

In a case where the projection position of the projection image G1 projected from the lens 34 is shifted in such a manner, the ghost 51 appears on the ceiling around the front of the lens 34 in the case in FIG. 7 where the projection image G1 is projected to the upper region of the projection object 6. Meanwhile, in the case of FIG. 8 where the projection image G1 is projected to the lower region of the projection object 6, the ghost 51 does not appear on the ceiling around the front of the lens 34 (in FIG. 8, a state where the ghost 51 does not appear is indicated by a broken line). Specifically, in FIG. 8, the ghost 51 does not appear on the ceiling by shifting the projection position of the projection image G1 such that an upper end portion of the projection image G1 projected to the projection object 6 is projected to a position below the position 54 at a predetermined height in the projection object 6. However, a necessary shift amount of the projection image G1 changes depending on a distance from the lens 34 to the projection object 6.

The examples illustrated in FIG. 7 and FIG. 8 describe a case where how the ghost 51 appears changes depending on the projection position of the projection image G1 projected from the lens 34. However, for example, in a case where how the ghost 51 appears changes depending on the above distance between the object 50 as the installation target on which the projection apparatus 10 is installed and the lens 34, the ghost 51 is more likely to appear as the distance between both of the object 50 and the lens 34 is decreased, and the ghost is less likely to occur as the distance between both of the object 50 and the lens 34 is increased. In addition, in a case where how the ghost 51 appears changes depending on the intensity of the light output from the lens 34, the ghost 51 is more likely to appear as an output value of the output light is increased, and the ghost 51 is less likely to appear as the output value of the output light is decreased.

<Shift Restriction for Preventing Ghost 51 from Appearing>

Next, shift restriction of the projection image G1 for preventing the ghost 51 from appearing will be described. FIG. 9 is a diagram for describing an example of the shift restriction of the projection image G1. As illustrated in FIG. 9, the projection apparatus 10 is installed in a state where the projection apparatus 10 is embedded in the “wall” which is the object 50 as the installation target. This installation state is the same installation state as the case described using FIG. 6.

In a case where the projection apparatus 10 is installed in such a state, the ghost 51 appears in accordance with the projection position of the projection image G1 projected from the lens 34. The ghost 51 appears on the wall around the front of the lens 34. The ghost 51 appears in a case where the projection position of the projection image G1 is close to the “wall” in which the projection apparatus 10 is installed, weakens (darkens) as the projection position is separated, and does not appear in a case where the projection position is separated by a predetermined distance or more. Accordingly, by setting the projection position of the projection image G1 to an appropriate projection position in a positional relationship with the “wall” in which the projection apparatus 10 is installed, that is, by restricting a shiftable range of the projection image G1 to a predetermined range, the appearance of the ghost 51 can be reduced.

For example, as illustrated in FIG. 9, it is assumed that a direction in which the “wall” which is the object 50 as the installation target of the projection apparatus 10 extends is the direction X, and a direction perpendicular to the “wall” is the direction Y. The direction X and the direction Y are directions perpendicular to a direction of the optical axis K of the lens 34. In the installation state in FIG. 9, the appearance of the ghost 51 on the “wall” can be reduced by restricting the shiftable range of the projection image G1 in the direction Y to the predetermined range. Specifically, a shift range of the projection image G1 in the direction of the “wall” in which the projection apparatus 10 is installed, that is, a shift range of the projection image G1 in a −Y direction in the direction Y, is restricted. In the present example, the appearance of the ghost 51 can be reduced by performing the shift restriction such that a lower end portion 55 of the projection image G1 is projected to a position above a region 56 indicated by diagonal lines (in a +Y direction).

By restricting the shift range in a direction corresponding to a positional relationship between the lens 34 of the projection apparatus 10 and the object 50 as the installation target of the projection apparatus 10, the appearance of the ghost 51 on the object 50 can be reduced. For example, in a case where the projection apparatus 10 is installed on the floor below the projection apparatus 10, downward shifting of the projection image G1 projected from the lens 34 is restricted. In a case where the projection apparatus 10 is installed on the wall on a right side of the projection apparatus 10, rightward shifting of the projection image G1 projected from the lens 34 is restricted. In a case where the projection apparatus 10 is installed on the ceiling above the projection apparatus 10, upward shifting of the projection image G1 projected from the lens 34 is restricted.

The example illustrated in FIG. 9 illustrates the installation state where the projection apparatus 10 is embedded in the “wall” which is the object 50 as the installation target. However, as described using FIG. 5, the installation state may be a state where the projection apparatus 10 is placed on the “floor”. In a case where the projection apparatus 10 is installed on the “floor”, the distance between the lens 34 and the object 50 as the installation target of the projection apparatus 10 is longer than that in the installation state where the projection apparatus 10 is embedded in the “wall”. Thus, the shift range is restricted in accordance with the distance. In a case where the distance between the lens 34 and the object 50 as the installation target of the projection apparatus 10 is long, the restriction of the shift range is lessened, and the shiftable range is expanded.

While the above example describes a case where the ghost 51 appears on the object 50 (the floor, the wall, the ceiling, or the like) on which the projection apparatus 10 is installed, the object on which the ghost 51 appears is not limited to this. For example, in a case where another object that is present around the front of the lens 34 is present at a position closer to the lens 34 than the object 50 on which the projection apparatus 10 is installed, the ghost 51 may appear on the object. Accordingly, in such a case, the shift range of the projection image G1 may be restricted in accordance with a distance between the lens 34 and the object closest to the lens 34. Depending on an installation situation of the projection apparatus 10, the object closest to the lens 34 may be the object 50 as the installation target or another object such as a plate placed nearby.

Next, processing in the shift restriction of the projection apparatus 10 will be described.

### <First Processing Example of Shift Restriction>

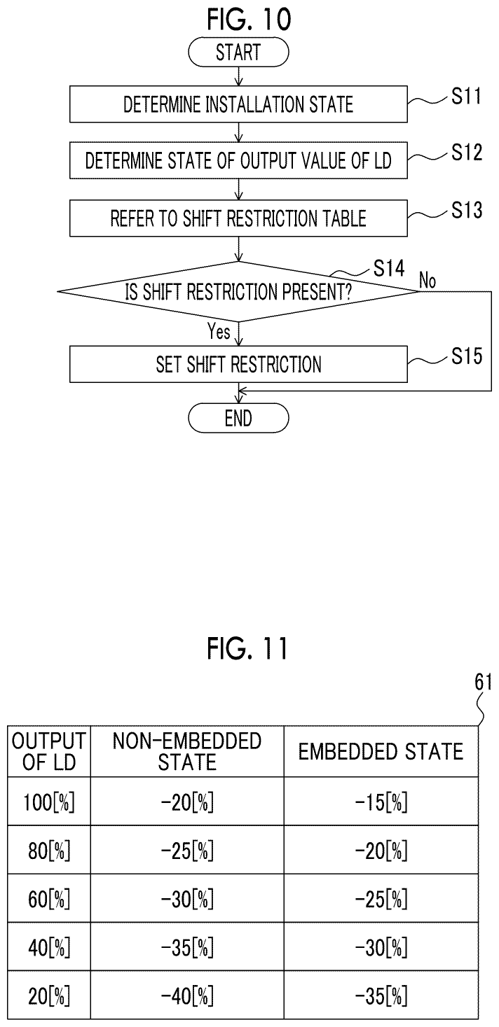

FIG. 10 is a flowchart illustrating a first processing example in the shift restriction of the projection apparatus 10. For example, the projection apparatus 10 starts executing the present processing when the projection apparatus 10 starts.

First, the projection apparatus 10 determines the installation state of the projection apparatus 10 (step S11). As described above, for example, the installation state of the projection apparatus 10 indicates whether the projection apparatus 10 is installed in the non-embedded state (refer to FIG. 5) or the embedded state (refer to FIG. 6 and FIG. 7) on the object 50 as the installation target. For example, the projection apparatus 10 determines the installation state based on a setting state of an installation mode switch that is set when the projection apparatus 10 is installed. The installation mode switch is set by a mode selection operation of the user. Alternatively, the projection apparatus 10 may determine the installation state based on sensing data provided by a camera or a three-dimensional sensor (LiDAR) mounted in the projection apparatus 10. Alternatively, for example, a remote controller reception portion may be mounted in each of the body part 101 and the optical unit 106, and the projection apparatus 10 may determine the installation state by a reception state of a signal (which remote controller reception portion has received the signal) based on an external remote controller operation.

Next, the projection apparatus 10 determines a state of the output value of the light source 21 (a laser diode (LD)) (step S12). For example, the state of the output value of the light source 21 is used for determining what percentage of the output value is with respect to the maximum output value of the light source 21.

Next, the projection apparatus 10 refers to a shift restriction table for setting the shift range of the projection image G1 based on the installation state of the projection apparatus 10 and the state of the output value of the light source 21 (step S13). The shift restriction table is stored in the memory 4a in advance as measured shift restriction data. The shift restriction table will be described later using FIG. 11.

Next, the projection apparatus 10 determines whether or not the shift restriction is present for the projection position of the projection image G1 projected from the lens 34 with reference to the shift restriction table (step S14).

In step S14, in a case where the shift restriction is not present for the projection position of the projection image G1 (step S14: No), the projection apparatus 10 finishes the present processing. In step S14, in a case where the shift restriction is present for the projection position of the projection image G1 (step S14: Yes), the projection apparatus 10 sets the shift restriction for the projection position of the projection image G1 projected from the lens 34 (step S15). In the present example, the presence or absence and a degree of the shift restriction of the projection image G1 are set based on the installation state of the projection apparatus 10 and the state of the output value of the light source 21.

While the first processing example describes a case where the present processing starts when the projection apparatus 10 starts, the present invention is not limited to this. For example, the present processing may be repeatedly executed after the projection apparatus 10 starts. The present processing may be executed when a change in the installation state of the projection apparatus 10 is detected or when a change in the output value of the light source 21 is detected. The present processing may be executed when an instruction to shift the projection image G1 is received from the user.

### <Example of Shift Restriction Table of First Processing Example>

FIG. 11 is a diagram illustrating an example of the shift restriction table in the above first processing example. As illustrated in FIG. 11, a shift restriction table 61 shows a shift restriction value of the projection apparatus 10 in the non-embedded state and a shift restriction value of the projection apparatus 10 in the embedded state with a predetermined output value of the light source 21.

For example, in a case where the output value of the light source 21 is 100%, the restriction of the shift range of the projection image G1 is set to a shift lower limit value of −20% when the projection apparatus 10 is in the non-embedded state. Meanwhile, when the projection apparatus 10 is in the embedded state, the restriction of the shift range of the projection image G1 is set to the shift lower limit value of −15%. For example, as described using FIG. 9, a negative (−) shift lower limit value is the shift restriction in the −Y direction of the direction Y, that is, the shift restriction in a direction of the object 50 on which the projection apparatus 10 is installed. The shift lower limit value of −20% is a ratio with respect to the maximum shift amount (−100%) in the −Y direction and indicates that the ghost 51 appears in a case where the shift amount in the −Y direction exceeds −20%.

Similarly, in a case where the output value of the light source 21 is 80%, the restriction of the shift range is set to the shift lower limit value of −25% when the projection apparatus 10 is in the non-embedded state, and the restriction of the shift range is set to the shift lower limit value of −20% when the projection apparatus 10 is in the embedded state. In a case where the output value of the light source 21 is 60%, the restriction of the shift range is set to the shift lower limit value of −30% when the projection apparatus 10 is in the non-embedded state, and the restriction of the shift range is set to the shift lower limit value of −25% when the projection apparatus 10 is in the embedded state. In a case where the output value of the light source 21 is 40%, the restriction of the shift range is set to the shift lower limit value of −35% when the projection apparatus 10 is in the non-embedded state, and the restriction of the shift range is set to the shift lower limit value of −30% when the projection apparatus 10 is in the embedded state. In a case where the output value of the light source 21 is 20%, the restriction of the shift range is set to the shift lower limit value of −40% when the projection apparatus 10 is in the non-embedded state, and the restriction of the shift range is set to the shift lower limit value of −35% when the projection apparatus 10 is in the embedded state.

In a case where the output value of the light source 21 is high, the ghost 51 is more likely to appear than that in a case where the output value of the light source 21 is low. Thus, a strong (strict) restriction is imposed on the shift range of the projection image G1. In a case where the installation state of the projection apparatus 10 is the embedded state, the distance between the lens 34 and the object 50 on which the projection apparatus 10 is installed is shorter than that in a case where the projection apparatus 10 is in the non-embedded state. Thus, the ghost 51 is likely to appear, and a strong restriction is imposed on the shift range of the projection image G1. Imposing a strong restriction on the shift range means narrowing a shiftable region. In the present example, the object 50 as the installation target of the projection apparatus 10 is present below the lens 34. Thus, the shift restriction table 61 for restricting the shift range of the projection image G1 in the downward direction is stored in the memory 4a. However, for example, a shift restriction table used in a case where the shift restriction in other directions is necessary may be prepared and stored in the memory 4a.

As described above, in the first processing example of the shift restriction, the projection apparatus 10 restricts the shiftable range of the projection image G1 based on information related to the installation state of the projection apparatus 10 and information related to the output value of the light source 21. According to this configuration, the projection image G1 of the projection apparatus 10 can be displayed at a predetermined distance or more corresponding to the output value of the light source 21 from the object present around the lens 34 of the projection apparatus 10. Accordingly, the ghost 51 that may appear on the object around the lens 34 of the projection apparatus 10, for example, the ghost 51 that may appear on the object 50 (the floor, the wall, or the like) on which the projection apparatus 10 is installed, based on the projection light can be reduced.

### <Second Processing Example of Shift Restriction>

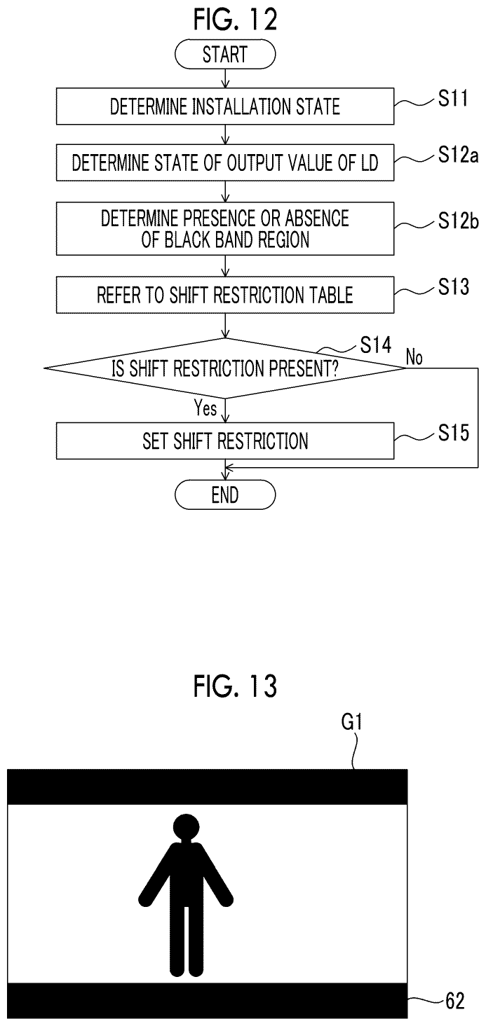

FIG. 12 is a flowchart illustrating a second processing example in the shift restriction of the projection apparatus 10. For example, as in the first processing example of the shift restriction, the projection apparatus 10 starts executing the present processing when the projection apparatus 10 starts.

As illustrated in FIG. 12, in the second processing example of the shift restriction, each processing from step S11 to step S12a is the same processing as each processing from step S11 to step S12 in the first processing example described using FIG. 10. Thus, step S11 and step S12a will not be described.

Next, the projection apparatus 10 determines whether or not a black band region is present in upper and lower regions of the projection image G1 to determine content of the currently projected projection image G1 (step S12b). For example, the black band region in the upper and lower regions of the projection image G1 is a dark region in which the upper and lower regions of the image appear to be black and missing as in a case where a horizontally long image of a movie is projected. The image including the black band region will be described later using FIG. 13.

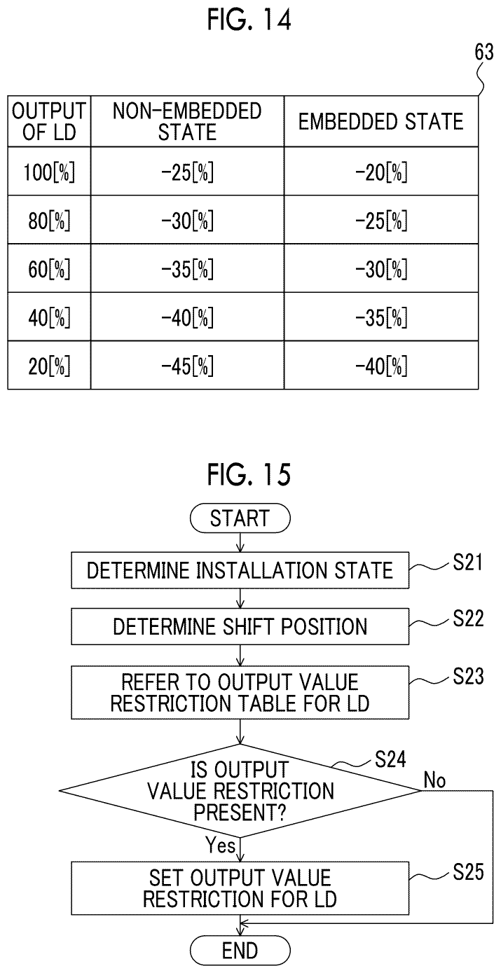

Next, the projection apparatus 10 refers to the shift restriction table for setting the shift range of the projection image G1 based on the installation state of the projection apparatus 10, the state of the output value of the light source 21, and the presence or absence of the black band region in the projection image G1 (step S13). The shift restriction table to be referred to will be described later using FIG. 14.

Each processing from step S14 to step S15 in the second processing example is the same processing as each processing from step S14 to step S15 in the first processing example described using FIG. 10. Thus, step S14 and step S15 will not be described. In the present example, the presence or absence and the degree of the shift restriction of the projection image G1 are set based on the installation state of the projection apparatus 10, the state of the output value of the light source 21, and the presence or absence of the dark region (the black band region) in the projection image G1.

### <Example of Black Band Region in Projection Image G1>

FIG. 13 is a diagram illustrating an example of the black band region in the projection image G1. As illustrated in FIG. 13, a black band region 62 is provided in a band shape that horizontally extends from the left end to the right end in each of the upper and lower end portions of the projection image G1. Brightness of the projection image G1 in which the black band region 62 is provided is lower than brightness of the projection image G1 in which the black band region 62 is not provided. Thus, the restriction of the shift range of the projection image G1 is lessened. The brightness of the projection image G1 may be determined from information on the presence or absence of the black band region 62 or may be determined from a representative value of pixel values. Examples of the representative value of the pixel values include an average value of brightness of each pixel, a total value of the brightness of the pixels of the entire image, a median value of the brightness of the pixels, and a mode. In a case where the projection image G1 is a moving image, for example, the representative value of the pixel values of each frame may be obtained, and the brightness of the projection image G1 may be determined from the representative values.

### <Example of Shift Restriction Table of Second Processing Example>

FIG. 14 is a diagram illustrating an example of the shift restriction table in the above second processing example. A shift restriction table 63 illustrated in FIG. 14 is a shift restriction table that is referred to in a case where the black band region is present in the upper and lower regions of the projection image G1. As illustrated in FIG. 14, the shift restriction table 63 shows the shift restriction value of the projection apparatus 10 in the non-embedded state and the shift restriction value of the projection apparatus 10 in the embedded state with the predetermined output value of the light source 21.

For example, in a case where the output value of the light source 21 is 100%, the restriction of the shift range of the projection image G is set to the shift lower limit value of −25% when the projection apparatus 10 is in the non-embedded state. Meanwhile, when the projection apparatus 10 is in the embedded state, the restriction of the shift range of the projection image G1 is set to the shift lower limit value of −20%. Similarly, in a case where the output value of the light source 21 is 80%, the restriction of the shift range is set to the shift lower limit value of −30% when the projection apparatus 10 is in the non-embedded state, and the restriction of the shift range is set to the shift lower limit value of −25% when the projection apparatus 10 is in the embedded state. In a case where the output value of the light source 21 is 60%, the restriction of the shift range is set to the shift lower limit value of −35% when the projection apparatus 10 is in the non-embedded state, and the restriction of the shift range is set to the shift lower limit value of −30% when the projection apparatus 10 is in the embedded state. In a case where the output value of the light source 21 is 40%, the restriction of the shift range is set to the shift lower limit value of −40% when the projection apparatus 10 is in the non-embedded state, and the restriction of the shift range is set to the shift lower limit value of −35% when the projection apparatus 10 is in the embedded state. In a case where the output value of the light source 21 is 20%, the restriction of the shift range is set to the shift lower limit value of −45% when the projection apparatus 10 is in the non-embedded state, and the restriction of the shift range is set to the shift lower limit value of −40% when the projection apparatus 10 is in the embedded state. As in the first processing example, the object 50 as the installation target is present below the lens 34 of the projection apparatus 10 in the installation state of the second processing example.

In a case where the black band region is present in the upper and lower regions of the projection image G1, a strong restriction is imposed on the shift range of the projection image G1 when the output value of the light source 21 is high, and a stronger restriction is imposed on the shift range of the projection image G1 when the installation state of the projection apparatus 10 is the embedded state than when the installation state of the projection apparatus 10 is the non-embedded state. This point is the same as the shift restriction table 61 referred to in the first processing example. Here, a restriction ratio [%] of the shift range is compared between the shift restriction table 63 in FIG. 14 and the shift restriction table 61 in FIG. 11. In the shift restriction table 63, the black band region is provided in the upper and lower regions, and the brightness of the projection image G1 is decreased by the black band region. Thus, the restriction ratio of the shift range is lower than that in the shift restriction table 61.

In step S12b in the above second processing example in FIG. 12, in a case where it is determined that the black band region is not present in the upper and lower regions of the projection image G1, the shift restriction table 61 in FIG. 11 is referred to as in the above first processing example in FIG. 10.

The present example describes the shift restriction in a case where the dark region (the black band region) that decreases the brightness of the image is present in the upper and lower regions of the projection image G1, and the object 50 as the installation target of the projection apparatus 10 is present below the lens 34. However, the present invention is not limited to this. The dark region that decreases the brightness of the image may be present not only in an upper end region and a lower end region but also in, for example, a left end region and a right end region of the projection image G1. Accordingly, the shift restriction of the projection image G1 may be imposed in accordance with a direction in which the dark region is present among a plurality of end portion regions of the projection image G1. For example, in a case where the dark region is present in the lower end region of the projection image G1, the shift range of the projection image G1 in the downward direction is not restricted, or the restriction is lessened. In a case where the dark region is present in the upper end region of the projection image G1, the shift range of the projection image G1 in the upward direction is not restricted, or the restriction is lessened. In a case where the dark region is present in the left end region of the projection image G1, the shift range of the projection image G1 in a leftward direction is not restricted, or the restriction is lessened. In a case where the dark region is present in the right end region of the projection image G1, the shift range of the projection image G1 in the rightward direction is not restricted, or the restriction is lessened.

As described above, in the second processing example of the shift restriction, the projection apparatus 10 restricts the shiftable range of the projection image G1 based on the information related to the installation state of the projection apparatus 10, the information related to the output value of the light source 21, and information related to brightness of the content of the projection image G1. According to this configuration, the projection image G1 in which the brightness of the content is taken into consideration can be displayed at the predetermined distance or more corresponding to the output value of the light source 21 from the object present around the lens 34 of the projection apparatus 10. Accordingly, the ghost 51 that may appear on the object around the lens 34 of the projection apparatus 10, for example, the ghost 51 that may appear on the object 50 (the floor, the wall, or the like) on which the projection apparatus 10 is installed, based on the projection light can be further appropriately reduced.

Next, output value restriction of the light source 21 with respect to a shift position of the projection image G1 will be described.

### <First Processing Example of Output Value Restriction of Light Source 21>

FIG. 15 is a flowchart illustrating a first processing example of the output value restriction of the light source 21 with respect to the shift position of the projection image G1. For example, the projection apparatus 10 starts executing the present processing when the projection apparatus 10 starts.

First, the projection apparatus 10 determines the installation state of the projection apparatus 10 (step S21). As in the above case, for example, the installation state of the projection apparatus 10 indicates whether the projection apparatus 10 is installed in the non-embedded state or the embedded state on the object 50 as the installation target.

Next, the projection apparatus 10 determines the shift position of the projection image G1 projected to the projection object 6 from the lens 34 (step S22). For example, the shift position of the projection image G1 is a shift position in the direction X or the direction Y in the projection apparatus 10 installed as illustrated in FIG. 9.

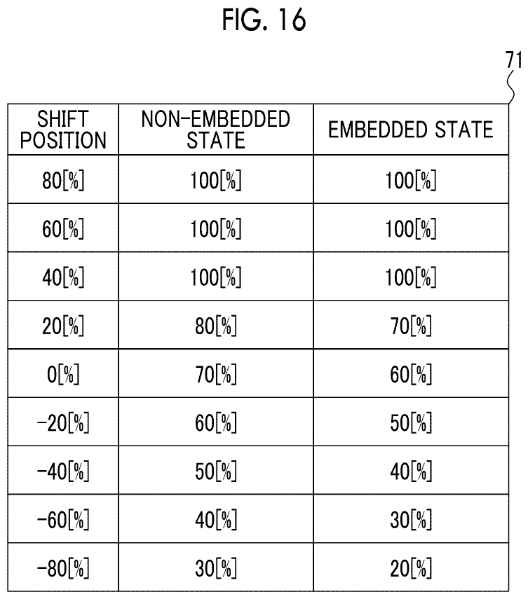

Next, the projection apparatus 10 refers to an output value restriction table for setting the output value of the light source 21 (LD) based on the installation state of the projection apparatus 10 and the shift position of the projection image G1 (step S23). The output value restriction table is stored in the memory 4a in advance as measured output value restriction data. The output value restriction table will be described later using FIG. 16.

Next, the projection apparatus 10 determines whether or not the output value restriction is present for the projection light output from the light source 21 with reference to the output value restriction table (step S24).

In step S24, in a case where the output value restriction is not present on the projection light from the light source 21 (step S24: No), the projection apparatus 10 finishes the present processing. In step S24, in a case where the output value restriction is present for the projection light from the light source 21 (step S24: Yes), the projection apparatus 10 sets the output value restriction for the projection light output from the light source 21 (step S25). In the present example, the presence or absence and a degree of the output value restriction of the light source 21 are set based on the installation state of the projection apparatus 10 and the shift position of the projection image G1.

In addition to executing the present processing when the projection apparatus 10 starts, the present processing may be repeatedly executed after the projection apparatus 10 starts, executed when the change in the installation state of the projection apparatus 10 is detected or when a change in the shift position of the projection image G1 is detected, or executed when an instruction of the output value is received from the user.

### <Example of Output Value Restriction Table in First Processing Example>

FIG. 16 is a diagram illustrating an example of the output value restriction table in the above first processing example. As illustrated in FIG. 16, an output value restriction table 71 shows an output restriction value of the projection apparatus 10 in the non-embedded state and an output restriction value of the projection apparatus 10 in the embedded state with a predetermined shift position of the projection image G1.

For example, in a case where the shift position of the projection image G1 is 80% to 40%, the output value restriction of the projection light from the light source 21 is set to 100% when the projection apparatus 10 is in any of the non-embedded state or the embedded state. For example, the shift position is a shift position in the direction Y in the projection apparatus 10 installed as illustrated in FIG. 9. A positive (+) shift position means that the shifting in the direction Y is performed in the +Y direction, that is, the shifting is performed in a direction going from the object 50 as the installation target of the projection apparatus 10. A negative (−) shift position means that the shifting in the direction Y is performed in the −Y direction, that is, the shifting is performed in a direction coming to the object 50 as the installation target of the projection apparatus 10. The shift position of 80% means that the shifting in the +Y direction is performed by shifting to a position of 80% of the maximum shift position (+100%). The output value restriction of 100% means that the ghost 51 does not appear even in a case where the output value of the light source 21 is the maximum output value (100%).

In a case where the shift position of the projection image G1 is 20%, the output value restriction of the projection light from the light source 21 is set to 80% when the projection apparatus 10 is in the non-embedded state, and the output value restriction of the projection light from the light source 21 is set to 70% when the projection apparatus 10 is in the embedded state. The output value restriction of 80% indicates that the ghost 51 appears in a case where the output value of the light source 21 exceeds 80%. In a case where the shift position of the projection image G1 is 0%, the output value restriction is set to 70% when the projection apparatus 10 is in the non-embedded state, and the output value restriction is set to 60% when the projection apparatus 10 is in the embedded state.

In a case where the shift position of the projection image G1 is −20%, the output value restriction is set to 60% when the projection apparatus 10 is in the non-embedded state, and the output value restriction is set to 50% when the projection apparatus 10 is in the embedded state. The shift position of −20% means that the shifting in the −Y direction is performed by shifting to a position of −20% of the maximum shift position (˜100%). In a case where the shift position of the projection image G1 is −40%, the output value restriction is set to 50% when the projection apparatus 10 is in the non-embedded state, and the output value restriction is set to 40% when the projection apparatus 10 is in the embedded state. In a case where the shift position of the projection image G1 is −60%, the output value restriction is set to 40% when the projection apparatus 10 is in the non-embedded state, and the output value restriction is set to 30% when the projection apparatus 10 is in the embedded state. In a case where the shift position of the projection image G1 is −80%, the output value restriction is set to 30% when the projection apparatus 10 is in the non-embedded state, and the output value restriction is set to 20% when the projection apparatus 10 is in the embedded state.

As the projection image G1 is shifted in the direction coming to the object 50 as the installation target of the projection apparatus 10, that is, as a negative value of the shift position is increased, the ghost 51 is more likely to appear. Thus, a strong (strict) restriction is imposed on the output value of the light source 21. In a case where the installation state of the projection apparatus 10 is the embedded state, the distance between the lens 34 and the object 50 on which the projection apparatus 10 is installed is shorter than that in a case where the projection apparatus 10 is in the non-embedded state. Thus, the ghost 51 is likely to appear, and a strong restriction is imposed on the output value of the light source 21.

As described above, in the first processing example of the output value restriction, the projection apparatus 10 restricts the output value of the light source 21 based on the information related to the installation state of the projection apparatus 10 and information related to the shift position of the projection image G1. According to this configuration, an outputtable range of the light source 21 can be restricted in accordance with the shift position of the projection image G1 projected from the projection apparatus 10. Thus, the ghost 51 that may appear on the object around the lens 34 of the projection apparatus 10, for example, the ghost 51 that may appear on the object 50 (the floor, the wall, or the like) on which the projection apparatus 10 is installed, based on the projection light can be reduced.

### <Second Processing Example of Output Value Restriction of Light Source 21>

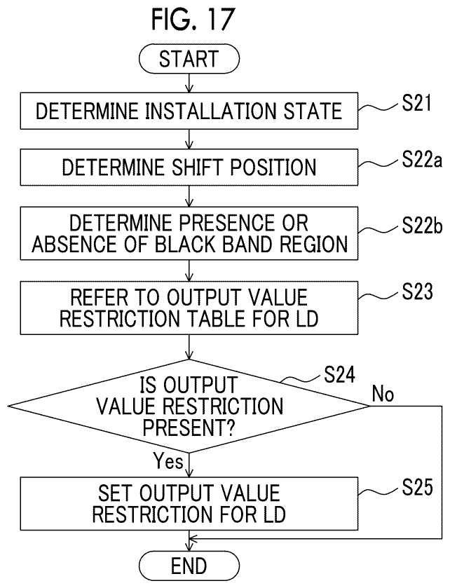

FIG. 17 is a flowchart illustrating a second processing example of the output value restriction of the light source 21 with respect to the shift position of the projection image G1. For example, as in the first processing example of the output value restriction, the projection apparatus 10 starts executing the present processing when the projection apparatus 10 starts.

As illustrated in FIG. 17, in the second processing example of the output value restriction, each processing from step S21 to step S22a is the same processing as each processing from step S21 to step S22 in the first processing example described using FIG. 15. Thus, step S21 and step S22a will not be described.

Next, the projection apparatus 10 determines whether or not the black band region is present in the upper and lower regions of the projection image G1 to determine the content of the currently projected projection image G1 (step S22b). For example, as described above in FIG. 13, the black band region in the upper and lower regions of the projection image G1 is a dark region in which the upper and lower regions of the image appear to be black and missing as in a case where a horizontally long image of a movie is projected.

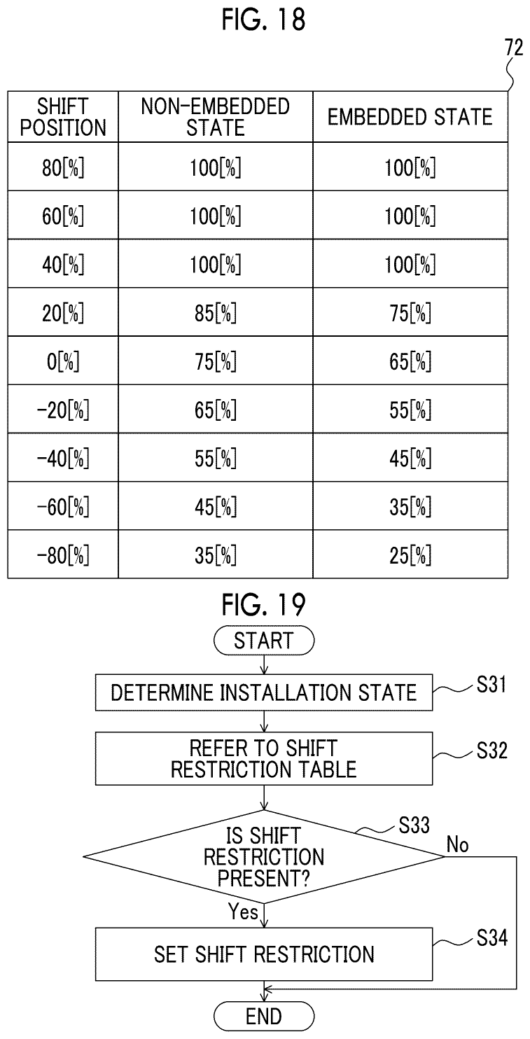

Next, the projection apparatus 10 refers to an output value restriction table for setting the output value of the light source 21 (LD) based on the installation state of the projection apparatus 10, the shift position of the projection image G1, and the presence or absence of the black band region in the projection image G1 (step S23). The output value restriction table will be described later using FIG. 18.

Each processing from step S24 to step S25 in the second processing example is the same processing as each processing from step S24 to step S25 in the first processing example described using FIG. 15. Thus, step S24 and step S25 will not be described. In the present example, the presence or absence and the degree of the output value restriction of the light source 21 are set based on the installation state of the projection apparatus 10, the shift position of the projection image G1, and the presence or absence of the dark region (the black band region) in the projection image G1.

### <Example of Output Value Restriction Table in Second Processing Example>

FIG. 18 is a diagram illustrating an example of the output value restriction table in the above second processing example. An output value restriction table 72 illustrated in FIG. 18 is an output value restriction table that is referred to in a case where the black band region is present in the upper and lower regions of the projection image G1. As illustrated in FIG. 18, the output value restriction table 72 shows the output restriction value of the projection apparatus 10 in the non-embedded state and the output restriction value of the projection apparatus 10 in the embedded state with the predetermined shift position of the projection image G1.

For example, in a case where the shift position of the projection image G1 is 80% to 40%, the output value restriction of the projection light from the light source 21 is set to 100% when the projection apparatus 10 is in any of the non-embedded state or the embedded state. In a case where the shift position of the projection image G1 is 20%, the output value restriction of the light source 21 is set to 85% when the projection apparatus 10 is in the non-embedded state, and the output value restriction of the light source 21 is set to 75% when the projection apparatus 10 is in the embedded state. In a case where the shift position of the projection image G1 is 0%, the output value restriction is set to 75% when the projection apparatus 10 is in the non-embedded state, and the output value restriction is set to 65% when the projection apparatus 10 is in the embedded state. In a case where the shift position of the projection image G1 is −20%, the output value restriction is set to 65% when the projection apparatus 10 is in the non-embedded state, and the output value restriction is set to 55% when the projection apparatus 10 is in the embedded state. In a case where the shift position of the projection image G1 is −40%, the output value restriction is set to 55% when the projection apparatus 10 is in the non-embedded state, and the output value restriction is set to 45% when the projection apparatus 10 is in the embedded state. In a case where the shift position of the projection image G1 is −60%, the output value restriction is set to 45% when the projection apparatus 10 is in the non-embedded state, and the output value restriction is set to 35% when the projection apparatus 10 is in the embedded state. In a case where the shift position of the projection image G1 is −80%, the output value restriction is set to 35% when the projection apparatus 10 is in the non-embedded state, and the output value restriction is set to 25% when the projection apparatus 10 is in the embedded state.

In a case where the black band region is present in the upper and lower regions of the projection image G1, a stronger restriction is imposed on the output value of the light source 21 as the projection image G1 is shifted in the direction coming to the object 50 as the installation target of the projection apparatus 10, and a stronger restriction is imposed on the output value of the light source 21 when the installation state of the projection apparatus 10 is the embedded state than when the installation state of the projection apparatus 10 is the non-embedded state. This point is the same as the output value restriction table 71 referred to in the first processing example. Here, a restriction ratio [%] of the output value is compared between the output value restriction table 72 in FIG. 18 and the output value restriction table 71 in FIG. 16. In the output value restriction table 72, the black band region is provided in the upper and lower regions, and the brightness of the projection image G1 is decreased by the black band region. Thus, the restriction ratio of the output value is lower than that in the output value restriction table 71.

In step S22b in the above second processing example in FIG. 17, in a case where it is determined that the black band region is not present in the upper and lower regions of the projection image G1, the output value restriction table 71 in FIG. 16 is referred to as in the above first processing example in FIG. 15.

As described above, in the second processing example of the output value restriction, the projection apparatus 10 restricts the output value of the light source 21 based on the information related to the installation state of the projection apparatus 10, the information related to the shift position of the projection image G1, and the information related to the brightness of the content of the projection image G1. According to this configuration, the outputtable range of the light source 21 can be restricted in accordance with the shift position of the projection image G1 in which the brightness of the content is taken into consideration. Thus, the ghost 51 that may appear on the object around the lens 34 of the projection apparatus 10, for example, the ghost 51 that may appear on the object 50 (the floor, the wall, or the like) on which the projection apparatus 10 is installed, based on the projection light can be further appropriately reduced.

### <First Modification Example of Shift Restriction>

FIG. 19 is a flowchart illustrating a first modification example of the shift restriction of the projection apparatus 10. In the present modification example, the presence or absence and the degree of the shift restriction of the projection image G1 are set based on only the installation state of the projection apparatus 10. For example, as in the first processing example of the shift restriction, the projection apparatus 10 starts executing the present processing when the projection apparatus 10 starts.

As illustrated in FIG. 19, in the first modification example of the shift restriction, processing of step S31 is the same processing as processing of step S11 in the first processing example described using FIG. 10.

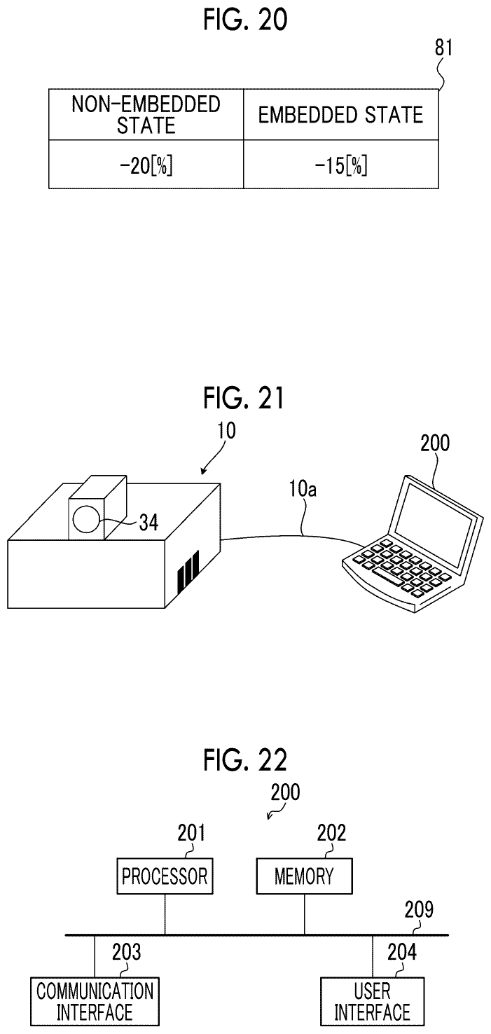

Next, the projection apparatus 10 refers to a shift restriction table for setting the shift range of the projection image G1 based on the installation state of the projection apparatus 10 (step S32). The shift restriction table will be described later using FIG. 20.

Next, the projection apparatus 10 determines whether or not the shift restriction is present for the projection image G1 projected from the lens 34 with reference to the shift restriction table (step S33).

Each processing from step S33 to step S34 in the present modification example is the same processing as each processing from step S14 to step S15 in the first processing example described using FIG. 10.

### <Example of Shift Restriction Table of First Modification Example>

FIG. 20 is a diagram illustrating an example of the shift restriction table in the above first modification example. As illustrated in FIG. 20, a shift restriction table 81 shows the shift restriction value of the projection apparatus 10 in the non-embedded state and the shift restriction value of the projection apparatus 10 in the embedded state.

In a case where the projection apparatus 10 is in the non-embedded state, the restriction of the shift range of the projection image G1 is set to the shift lower limit value of −20%. Meanwhile, in a case where the projection apparatus 10 is in the embedded state, the restriction of the shift range of the projection image G1 is set to the shift lower limit value of −15%. This indicates that the ghost 51 appears in a case where the shift amount of the projection image G1 in the −Y direction exceeds −20% in the non-embedded state, and the ghost 51 appears in a case where the shift amount of the projection image G1 in the −Y direction exceeds −15% in the embedded state. In a case where the installation state of the projection apparatus 10 is the embedded state, the distance between the lens 34 and the object 50 on which the projection apparatus 10 is installed is shorter than that in a case where the projection apparatus 10 is in the non-embedded state. Thus, the ghost 51 is likely to appear, and the shift range of the projection image G1 is strongly restricted.

As described above, in the first modification example of the shift restriction, the projection apparatus 10 restricts the shiftable range of the projection image G1 based on the information related to the installation state of the projection apparatus 10. According to this configuration, the projection image G1 of the projection apparatus 10 can be displayed at a necessary predetermined distance or more from the object present around the lens 34 of the projection apparatus 10. Accordingly, the ghost 51 that may appear on the object around the lens 34 of the projection apparatus 10, for example, the ghost 51 that may appear on the object 50 (the floor, the wall, or the like) on which the projection apparatus 10 is installed, based on the projection light can be reduced.

### <Second Modification Example of Shift Restriction>

Next, a control of the shift restriction in a case where information on the shift restriction of the projection image G1 changes during the projection of the projection image G1 will be described. Examples of the information related to the shift restriction include information related to the change in the output value of the light source 21 and information related to the change in the installation state of the projection apparatus 10. The information related to the change in the output value of the light source 21 is information indicating that the shift restriction of the projection image G1 is strengthened as the output value of the light source 21 is increased, and the shift restriction of the projection image G1 is lessened as the output value of the light source 21 is decreased. The information related to the change in the installation state of the projection apparatus 10 is information indicating that the shift restriction of the projection image G1 is strengthened when the projection apparatus 10 is in the embedded state, and the shift restriction of the projection image G1 is lessened when the projection apparatus 10 is in the non-embedded state.

In a case where the information related to the shift restriction changes during the projection of the projection image G1, the projection apparatus 10 performs a control of maintaining a state of the shifting of the projection image G1. For example, it is assumed that the output value of the light source 21 is increased during the projection of the projection image G1. Even in a case where this change in the output value causes the current shift position of the projection image G1 to fall outside the shiftable region, the projection apparatus 10 maintains the current shift position during the projection of the projection image G1. That is, even in a case where the output value of the light source 21 is increased, and the ghost 51 appears with the current shift position, the position of the projection image G1 is not changed, and the original position is maintained during the projection.

According to the second modification example of the shift restriction, even in a case where the information related to the shift restriction changes during the projection of the projection image G1, the projection position of the projection image G1 is maintained at the original position. Thus, awkwardness caused by moving the position of the projection image G1 during the projection can be prevented.

Even in a state where the state of the shifting of the projection image G1 is maintained as described above, a control of changing the state of the shifting of the projection image G1 is performed in accordance with the information related to the shift restriction in a case where a user operation related to the shifting of the projection image G1 is performed. For example, it is assumed that the user performs an operation of changing the shift position of the projection image G1 in a state where the shift state of the projection image G1 is maintained. In this case, even during the projection of the projection image G1, the shift position of the projection image G1 is changed such that the position of the projection image G1 is shiftable within the region in which the position of the projection image G1 is shiftable with respect to the changed output value of the light source 21.

According to this configuration, the position of the projection image G1 is moved to the shiftable region in response to the operation of changing the position of the projection image G1 performed by the user. Thus, the user can be prevented from feeling awkward with respect to the movement of the position of the projection image G1 during the projection. In addition, by moving the position of the projection image G1 to the shiftable region, the ghost 51 that may appear on the object around the lens 34 of the projection apparatus 10, for example, the ghost 51 that may appear on the object 50 (the floor, the wall, or the like) on which the projection apparatus 10 is installed, based on the projection light can be reduced.

### <Modification Example of Configuration of Projection Apparatus 10>

FIG. 21 is a diagram illustrating a modification example of a configuration of the projection apparatus 10. In the above embodiment, the control device 4 that controls the projection apparatus 10 is provided in the body part 101 of the projection apparatus 10. However, the present invention is not limited to this. The control device 4 may be, for example, a processor 201 (refer to FIG. 13) mounted in a personal computer 200 outside the projection apparatus 10. The processor 201 may comprise all or a part of functions of the control device 4 in the projection apparatus 10. The personal computer 200 is connected to the projection apparatus 10 in a communicable manner through a signal line 10a. The personal computer 200 may be connected to the projection apparatus 10 in a wirelessly communicable manner.

### <Hardware Configuration of Personal Computer 200>

FIG. 22 is a diagram illustrating an example of a hardware configuration of the personal computer 200. As illustrated in FIG. 22, the personal computer 200 illustrated in FIG. 21 comprises the processor 201, a memory 202, a communication interface 203, and a user interface 204. The processor 201, the memory 202, the communication interface 203, and the user interface 204 are connected through, for example, a bus 209.

The processor 201 is a circuit that performs signal processing and is, for example, a CPU that controls the entire personal computer 200. The processor 201 may be implemented by other digital circuits such as an FPGA and a digital signal processor (DSP). The processor 201 may be implemented by a combination of a plurality of digital circuits.

The memory 202 includes, for example, a main memory and an auxiliary memory. The main memory is, for example, a random access memory (RAM). The main memory is used as a work area of the processor 201.

The auxiliary memory is, for example, a non-volatile memory such as a magnetic disk, an optical disc, or a flash memory. The auxiliary memory stores various programs for operating the personal computer 200. The programs stored in the auxiliary memory are loaded into the main memory and executed by the processor 201.

The auxiliary memory may include a portable memory that can be detached from the personal computer 200. Examples of the portable memory include a universal serial bus (USB) flash drive, a memory card such as a secure digital (SD) memory card, and an external hard disk drive.

The communication interface 203 is a communication interface for communicating with the outside of the personal computer 200 (for example, an external communication portion of the projection apparatus 10). The communication interface 203 is controlled by the processor 201. The communication interface 203 may be a wired communication interface for performing wired communication or a wireless communication interface for performing wireless communication, or may include both of the wired communication interface and the wireless communication interface.

The user interface 204 includes, for example, an input device that receives an operation input from the user, and an output device that outputs information to the user. The input device can be implemented by, for example, a pointing device (for example, a mouse), a key (for example, a keyboard), or a remote controller. The output device can be implemented by, for example, a display or a speaker. The input device and the output device may be implemented by a touch panel or the like. The user interface 204 is controlled by the processor 201.

A control method described in the above embodiment can be implemented by causing a computer to execute a control program prepared in advance. The present control program is recorded on a computer-readable storage medium and executed by reading out the control program from the storage medium. The present control program may be provided in the form of being stored in a non-transitory storage medium such as a flash memory or may be provided through a network such as the Internet. The computer that executes the present control program may be included in the control device, may be included in an electronic apparatus such as a smartphone, a tablet terminal, or a personal computer capable of communicating with the control device, or may be included in a server apparatus capable of communicating with the control device and the electronic apparatus.

### Modification Example

In the above description, the projection apparatus 10 or the personal computer 200 performs a control of restricting the shifting of the projection image in accordance with the installation state of the projection apparatus 10. However, the projection apparatus 10 or the personal computer 200 may perform a control of restricting enlargement of the projection image in accordance with the installation state of the projection apparatus 10 instead of the shifting of the projection image or in addition to the shifting of the projection image.

While various embodiments are described above, the present invention is not limited to such examples. Those skilled in the art may apparently perceive various modification examples or correction examples within the scope according to the claims, and those examples are also construed as falling within the technical scope of the present invention. In addition, each constituent in the embodiment may be arbitrarily combined without departing from the gist of the invention.

The present application is based on Japanese Patent Application (JP2023-070608) filed on Apr. 24, 2023, the content of which is incorporated in the present application by reference.

### EXPLANATION OF REFERENCES

1: projection portion
2: operation reception portion
2A, 3A: hollow portion
2a, 2b, 3a, 3c, 15a: opening
4: control device
4a, 202: memory
6: projection object
10: projection apparatus
10a: signal line
11: projection range
12: light modulation unit
15: housing
21: light source
22: light modulation portion
23: projection optical system
24: control circuit
31: second optical system
32, 122: reflective member
33: third optical system
34: lens
50: object
51: ghost
52: projection room
53: floor
54: position
55: lower end portion
56: region
61, 63, 81: shift restriction table
62: black band region
71, 72: output value restriction table
101: body part
102: first member
103: second member
104: projection direction changing mechanism
105: shift mechanism
106: optical unit
121: first optical system
200: personal computer
201: processor
203: communication interface
204: user interface
209: bus

G1: projection image

What is claimed is:

1. A projection apparatus comprising:
a projection lens; and
a processor,
wherein the processor is configured to:
acquire information related to an installation state of the projection apparatus; and
perform a control of restricting shifting of a projection image in accordance with the installation state and a state of a light source of the projection apparatus.

2. The projection apparatus according to claim 1,
wherein the installation state is a state related to a positional relationship between the projection lens and an object as an installation target of the projection apparatus.

3. The projection apparatus according to claim 1,
wherein the installation state includes an embedded state where at least a part of the projection apparatus is embedded in an object as an installation target of the projection apparatus.

4. The projection apparatus according to claim 3,
wherein the processor is configured to impose a stronger restriction on the shifting in the embedded state than in the installation state different from the embedded state.

5. The projection apparatus according to claim 1,
wherein the information related to the installation state includes information related to a distance between the projection lens and an object, other than the projection apparatus, that is closest to the projection lens, and
the processor is configured to restrict the shifting in accordance with the distance.

6. The projection apparatus according to claim 1,
wherein the information related to the installation state includes information related to a distance between the projection lens and an object as an installation target of the projection apparatus, and
the processor is configured to restrict the shifting in accordance with the distance.

7. The projection apparatus according to claim 1,
wherein the processor is configured to restrict the shifting in a direction corresponding to a positional relationship between the projection lens and an object as an installation target of the projection apparatus.

8. The projection apparatus according to claim 1,
wherein the state of the light source includes a state of an output value of the light source.

9. The projection apparatus according to claim 8,
wherein the processor is configured to, in a case where the output value is a first output value, impose a stronger restriction on the shifting than in a case where the output value is a second output value lower than the first output value.

10. The projection apparatus according to claim 1,
wherein the processor is configured to control an output value of a light source of the projection apparatus based on a state of the shifting.

11. The projection apparatus according to claim 1,
wherein the processor is configured to perform the control of restricting the shifting in accordance with the installation state and image content of the projection image.

12. The projection apparatus according to claim 11,
wherein the processor is configured to perform the control of restricting the shifting in accordance with the installation state and brightness of the image content of the projection image.

13. The projection apparatus according to claim 12,
wherein the processor is configured to restrict the shifting in a direction corresponding to brightness of a plurality of end portion regions in the image content of the projection image.

14. The projection apparatus according to claim 1,
wherein the processor is configured to, in a case where information related to the restriction of the shifting changes during projection of the projection image, maintain a state of the shifting.

15. The projection apparatus according to claim 14,
wherein the processor is configured to, in a case where a user operation related to the shifting is performed in a state where the state of the shifting is maintained, change the state of the shifting in accordance with the information related to the restriction of the shifting.

16. The projection apparatus according to claim 1,
wherein the shifting is shifting in a direction perpendicular to an optical axis direction of the projection lens.

17. A control method of a projection apparatus, the projection apparatus including a projection lens, and a processor, the control method comprising:
via the processor,
acquiring information related to an installation state of the projection apparatus; and
performing a control of restricting shifting of a projection image in accordance with the installation state and a state of a light source of the projection apparatus.

18. A non-transitory computer-readable storage medium storing a control program of a projection apparatus, the projection apparatus including a projection lens, and a processor, the control program causing the processor to execute a process comprising:
acquiring information related to an installation state of the projection apparatus; and
performing a control of restricting shifting of a projection image in accordance with the installation state and a state of a light source of the projection apparatus.

19. A projection apparatus comprising:
a projection lens; and
a processor,
wherein the processor is configured to:
acquire information related to an installation state of the projection apparatus;
perform a control of restricting shifting of a projection image in accordance with the installation state; and
control an output value of a light source of the projection apparatus based on a state of the shifting.

20. A projection apparatus comprising:
a projection lens; and
a processor,
wherein the processor is configured to:
acquire information related to an installation state of the projection apparatus; and
perform a control of restricting shifting of a projection image in accordance with the installation state and brightness of the image content of the projection image.
